(19) United States
(12) Patent Application Publication
(10) Pub. No.: US 2025/0386323 A1
(43) Pub. Date: Dec. 18, 2025

(54) RADIO COMMUNICATION SYSTEM, CONTROL APPARATUS, MOVE DESTINATION POSITION DETERMINATION METHOD, AND PROGRAM

(71) Applicant: NIPPON TELEGRAPH AND TELEPHONE CORPORATION, Tokyo (JP)

(72) Inventors: Daisuke MURAYAMA, Tokyo (JP); Toshiro NAKAHIRA, Tokyo (JP); So TAKATANI, Tokyo (JP)

(21) Appl. No.: 18/878,763

(22) PCT Filed: Jul. 4, 2022
(86) PCT No.: PCT/JP2022/026631

§ 371 Date: Dec. 24, 2024

(51) Int. Cl. H04W 64/00; H04W 24/02; H04W 84/00

(52) U.S. Cl. CPC H04W 64/006; H04W 24/02; H04W 64/003; H04W 84/005

(57) ABSTRACT

Provided is a wireless communication system including: one or more mobile wireless station devices that communicate with one or more terminal devices; and a control device, in which the control device calculates, on the basis of a prediction value of a position of each of the terminal devices, a movement destination position candidate of each of the mobile wireless station devices of which communication with the terminal device satisfies a required quality for each of a plurality of movements, and selects, as a combination of movement destination positions for movement control, a combination that minimizes a sum of movement costs for the plurality of movements from an original position of each of the mobile wireless station devices from among a plurality of the combinations of the movement destination position candidates in the plurality of movements.

### DESCRIPTION

### Technical Field

The present invention relates to a technology for controlling movement of a mobile wireless station device such as a movable base station device.

### Background Art

Wireless communication technologies such as 5G and wireless LAN are widely used. In recent years, a technology for providing a natural communication environment in which a base station device is moved according to a degree of congestion with terminal devices or a change in a spatial environment and thus a user is not aware of a wireless network has been studied (for example, Non Patent Literature 1).

### CITATION LIST

### Non Patent Literature

### Non Patent Literature 1: The Institute of Electronics, Information and Communication Engineers (IEICE) 2021 General Conference B-5-131

### SUMMARY OF INVENTION

### Technical Problem

As described above, by moving the base station device, it is possible to effectively utilize wireless resources and provide an appropriate wireless communication service to the terminal device.

However, in a case where the distance (or time) required to move the base station device is long, there is a possibility that the communication quality in the terminal device deteriorates during the movement. Furthermore, power consumption required for the movement increases. Note that the target to be moved is not limited to the base station device. For example, the target to be moved may be a relay station device, an access point (AP), or the like. The target to be moved will be collectively referred to as a “mobile wireless station device”.

The present invention has been made in view of the above-described points, and an object of the present invention is to provide a technology for suppressing deterioration in quality of the communication during movement and suppressing an increase in power consumption for movement when movement control on the mobile wireless station device is performed.

### Solution to Problem

According to the disclosed technology, there is provided a wireless communication system including:

one or more mobile wireless station devices that communicate with one or more terminal devices; and

a control device,

in which the control device

calculates, on the basis of a prediction value of a position of each of the terminal devices, a movement destination position candidate of each of the mobile wireless station devices of which communication with the terminal device satisfies a required quality for each of a plurality of movements, and

selects, as a combination of movement destination positions for movement control, a combination that minimizes a sum of movement costs for the plurality of movements from an original position of each of the mobile wireless station devices from among a plurality of the combinations of the movement destination position candidates in the plurality of movements.

### Advantageous Effects of Invention

According to the disclosed technology, it is possible to suppress deterioration in quality of the communication during movement and suppress an increase in power consumption for movement when movement control on the mobile wireless station device is performed.

### BRIEF DESCRIPTION OF DRAWINGS

FIG. 1 is a diagram illustrating an overall configuration example of a system.

FIG. 2 is a diagram for explaining an outline of determination operation for a movement destination position by a control device 30.

FIG. 3 is a diagram illustrating a device configuration example.

FIG. 4 is a flowchart for explaining operation of the control device 30.

FIG. 5 is a diagram illustrating hierarchical clustering.

FIG. 6 is a diagram illustrating a hardware configuration example of a device.

### DESCRIPTION OF EMBODIMENTS

Hereinafter, an embodiment of the present invention (present embodiment) will be described with reference to the drawings. The embodiment to be described below is merely an example, and embodiments to which the present invention is applied are not limited to the following embodiment.

In the following description of the embodiment, a movable base station device is used as a mobile wireless station device to be moved, but this is an example. The base station device to be described below may be replaced with a relay station device, an AP, or a mobile wireless station device other than the relay station device and the AP.

Furthermore, the base station device may be a base station device in a cellular communication network (for example, 3G, 4G/LTE, 5G, and 6G), a base station device in a wireless LAN, or a base station device in a communication method other than these. Note that hereinafter, the base station device may be referred to as a “BS”.

### (Overall Configuration Example of System)

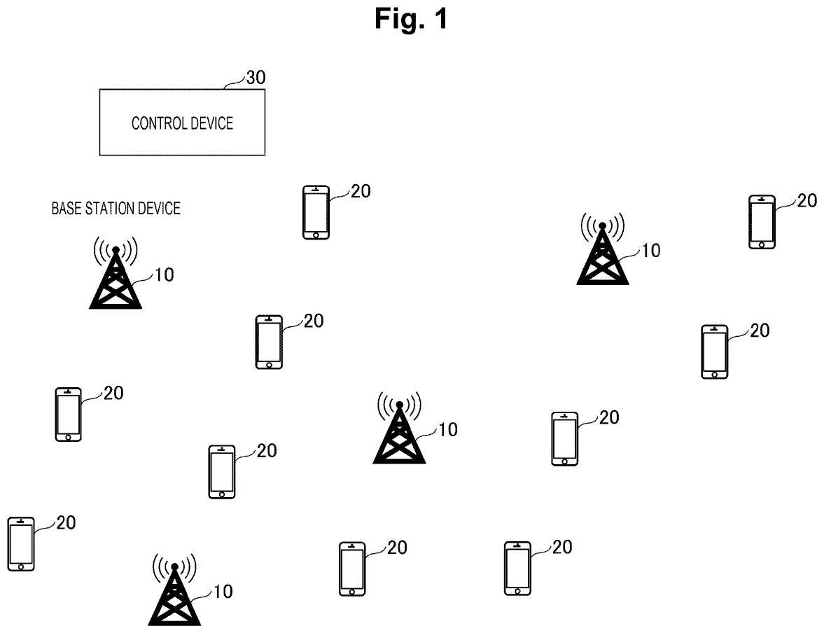

FIG. 1 illustrates an overall configuration example of a system according to the present embodiment. As illustrated in FIG. 1, in this system, there are a plurality of base station devices 10 and a plurality of terminal devices 20. Furthermore, there is a control device 30 that performs movement control on the base station devices 10. A system including one or more base station devices 10 and the control device 30 may be referred to as a wireless communication system.

Each of the base station devices 10 can move on the basis of control from the control device 30. The base station device 10 may be referred to as a movable base station device. Any means may be used for the movement. For example, the movement may be implemented by mounting the base station device 10 on a drone, the base station device 10 may be movable on a rail by being mounted on the rail, the movement may be implemented by mounting the base station device 10 on a vehicle, or the movement may be implemented by other methods. Here, the “base station device 10” also includes a movement means (drive unit).

Furthermore, in a case where the direction of an antenna included in the base station device 10 is variable, the control device 30 can change the direction of the antenna included in the base station device 10.

Each of the base station devices 10 can wirelessly communicate with each of the terminal devices 20. Furthermore, each base station device 10 can communicate with the control device 30 in a wired or wireless manner. The terminal device 20 can wirelessly communicate with one or a plurality of the base station devices 10. Furthermore, the control device 30 can predict a future position of each terminal device 20.

### (Outline of Determination Operation for Movement Destination Position by Control Device 30)

As described above, in a case where the distance (or time) required to move the base station device 10 is long, there is a possibility that the communication quality in the terminal device 20 deteriorates during the movement. Furthermore, power consumption required for the movement increases.

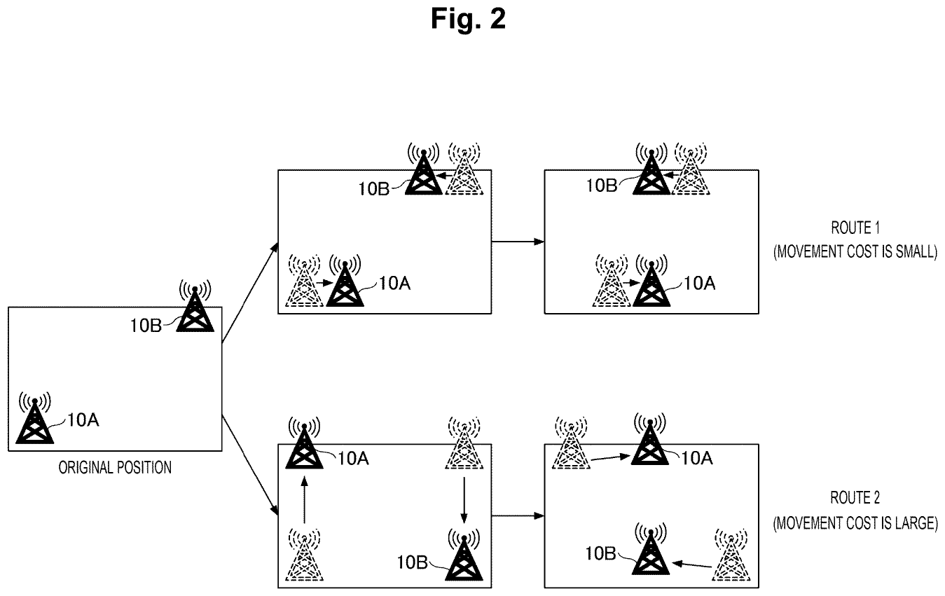

Therefore, in the present embodiment, the control device 30 determines the movement destination position of the base station device 10 in consideration of the movement cost of the base station device 10. An outline of a determination method for a movement destination position will be described with reference to FIG. 2.

First, the control device 30 predicts a future position of each terminal device 20. “Predicting a future position” may be expressed as “predicting a position”. The “future position” is, for example, a position at a time point X seconds ahead from the current time (for example, a time point at which the control device 30 executes prediction). X may be a predetermined value or a value determined by a prediction method.

As a method of predicting the position of each terminal device 20, any method may be used. For example, the control device 30 can collect information regarding a current position and movement speed of each terminal device 20 and predict the future position from the current position and the movement speed.

Furthermore, in a case where the environment of the present system is an environment such as a factory of which a layout is frequently changed, the control device 30 acquires planned layout change information in advance. In a case where the layout change information includes the position of each terminal device 20, the control device 30 can predict the position of the terminal device 20 after the layout change from the layout change information.

Furthermore, the control device 30 can also predict the movement (future position) of the terminal device 20 (terminal device 20 held by a person) by a people flow simulation using machine learning or the like.

The control device 30 determines the position of the movement destination of each base station device 10 on the basis of the predicted position of each terminal device 20. For example, the control device 30 determines a candidate for the position of the movement destination of each base station device 10 at time T1 (the position where each base station device 10 should be present at time T1) on the basis of the position of each terminal device 20 at time T1 in the future. Although the number of candidates is plural, the number of candidates may be one. A method for determining a candidate will be described later.

Next, the control device 30 determines a candidate for the position of the movement destination of each base station device 10 at time T2 (the position where each base station device 10 should be present at time T2) on the basis of the position of each terminal device 20 at time T2 later than time T1.

As described above, the control device 30 determines a candidate for the position of the movement destination of each base station device 10 up to a plurality of times (N times). In the above-described example, N=2, but N may be three or more.

FIG. 2 illustrates an example of a case where movement destination position candidates up to two times ahead are calculated. In the example of FIG. 2, two pattern candidates, that is, a pattern candidate of a route 1 and a pattern candidate of a route 2 are illustrated as pattern candidates of movement in two movements (a combination of movement destination position candidates of an example).

Note that in the example of FIG. 2, there are two candidates as a first movement destination, and one candidate is determined as a second movement destination, but this is an example. For example, two candidates may be determined as the second movement destination. In this case, a total of four pattern candidates are obtained.

The control device 30 executes the movement of each base station device 10 by calculating a movement cost of each pattern candidate among a plurality of the pattern candidates, selecting one pattern candidate from among a plurality of the pattern candidates on the basis of the movement cost, and using the selected pattern candidate as a movement pattern. Details of a movement cost calculation method and a pattern candidate determination method will be described later.

In the example of FIG. 2, the control device 30 selects the pattern candidate of the route 1 having a small movement cost from the pattern candidate of the route 1 and the pattern candidate of the route 2, and executes the movement of each base station device 10 with the pattern of the route 1.

### (Device Configuration Example)

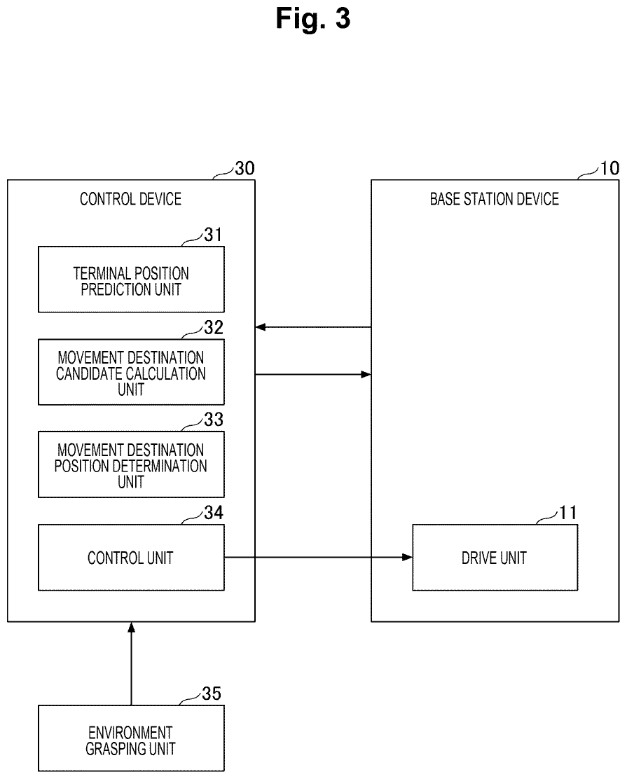

FIG. 3 illustrates a configuration example of devices constituting a wireless communication system according to the present embodiment. As illustrated in FIG. 3, this wireless communication system includes the control device 30 and the base station device 10. As described above, the base station device 10 is an example of a mobile wireless station device to be subjected to movement control. Although FIG. 3 illustrates one base station device 10, there are actually one or more base station devices 10.

The control device 30 and the base station device 10 are connected in a wired or wireless manner. Furthermore, as illustrated in FIG. 1, the base station device 10 can wirelessly communicate with the terminal device 20.

The base station device 10 includes a drive unit 11. The drive unit 11 moves the base station device 10 to a desired position in accordance with an instruction from a control unit 34 of the control device 30.

The control device 30 includes a terminal position prediction unit 31, a movement destination candidate calculation unit 32, a movement destination position determination unit 33, and the control unit 34. Furthermore, in the example of FIG. 3, an environment grasping unit 35 (a camera, a sensor, and the like) is provided outside the control device 30.

The terminal position prediction unit 31 predicts the position of each terminal device 20 by, for example, the above-described method. For example, the terminal position prediction unit 31 acquires the local position of the terminal device 20 and the movement speed of the terminal device from the base station device 10 or the terminal device 20, and predicts the position of the terminal device 20.

Furthermore, the terminal position prediction unit 31 may acquire information indicating the arrangement of each terminal device 20 acquired by the environment grasping unit 35, and predict the position of the terminal device 20 from the information and the layout change information.

The movement destination candidate calculation unit 32 calculates the movement pattern candidate of the base station device 10 on the basis of the prediction result obtained by the terminal position prediction unit 31. The movement destination position determination unit 33 determines a movement pattern to be used for actual movement control (movement destination position of each base station device 10 in each movement) from a plurality of the movement pattern candidates.

The control unit 34 performs control to move each base station device 10 to the movement destination position of each base station device 10 determined by the movement destination position determination unit 33. Note that the control unit 34 may be provided outside the control device 30.

### (Operation Example)

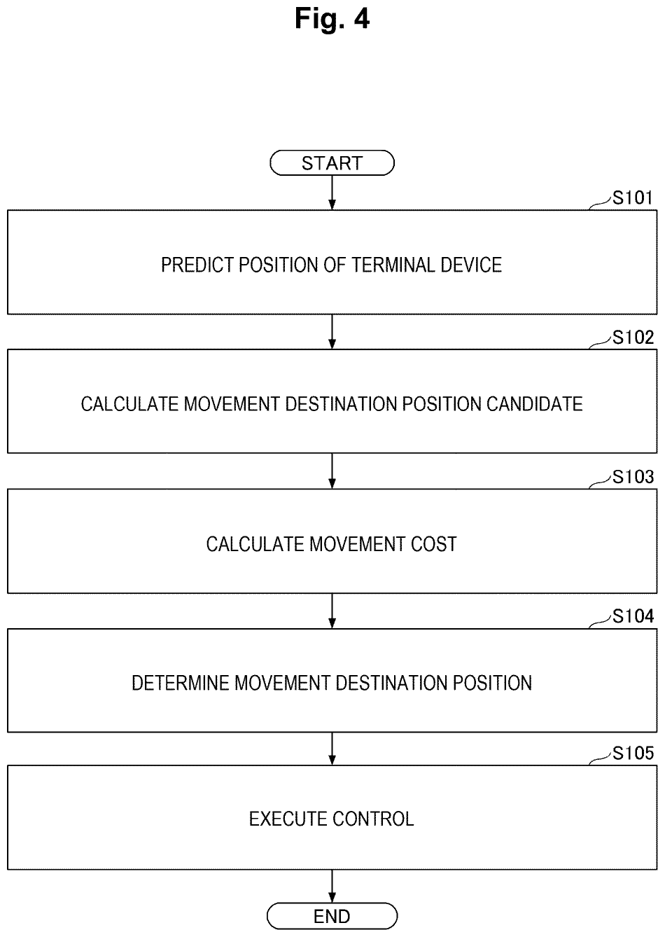

Next, the operation of the control device 30 will be described according to procedures of the flowchart of FIG. 4. In the operation to be described below, it is assumed that there is an area (referred to as a target area) which the control device 30 supports, and the terminal device 20 and the base station device 10 in the target area are control targets. Furthermore, one or a plurality of terminal devices 20 and one or a plurality of base station devices 10 are present in the target area.

Furthermore, in the present example, movement destination position candidates of each base station device 10 up to N times ahead are calculated. N is an integer of one or more. For example, the value of N may be set in the control device 30 in advance.

### <S101>

In S101, the terminal position prediction unit 31 predicts the position of each terminal device 20. Here, a prediction value of the position of each terminal device 20 necessary for calculating movement destination position candidates of each base station device 10 up to N times ahead is calculated.

### <S102>

In S102, the movement destination candidate calculation unit 32 calculates the movement destination position candidates of each base station device 10 up to N times ahead on the basis of the prediction value of the terminal position obtained by the terminal position prediction unit 31. That is, the movement destination candidate calculation unit 32 calculates a movement destination position candidate for the first movement, a movement destination position candidate for the second movement, . . . , and a movement destination position candidate for the Nth movement.

In calculating the movement destination position candidate of the nth movement, the prediction value of the terminal position at the time when the nth movement is performed (the time when the base station device 10 arrives at the movement destination of the nth movement) is used.

A calculation method for a movement destination position candidate of each base station device 10 at each time is not limited to a specific method, but for example, the following calculation method example 1 or calculation method example 2 can be used.

Note that in the following calculation method example 1 and calculation method example 2, it is assumed that the antenna of the base station device 10 is an omnidirectional antenna. In a case where the antenna of the base station device 10 is an antenna having directivity (in a case of an antenna of which the direction can be changed), for example, in the following calculation of a predicted communication quality, the predicted communication quality is only required to be calculated in a case where the antenna is directed in a direction in which the predicted communication quality is best.

### (Calculation Method Example 1)

The movement destination candidate calculation unit 32 first randomly changes a terminal clustering initial value for a plurality of terminal devices 20 in the target area, and performs terminal clustering by a k-means method. Specifically, for example, the terminal clustering initial values corresponding to the number of target base station devices 10 (denoted as M) are set, and a plurality of the terminal devices 20 are divided into M clusters. Such clustering is performed a plurality of times by randomly changing the terminal clustering initial value.

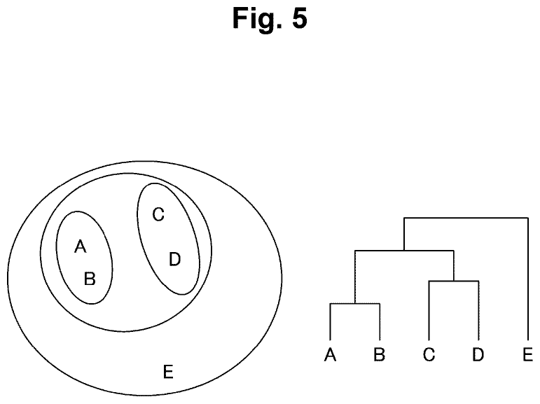

Note that the clustering may be performed using hierarchical clustering disclosed in Non Patent Literature 1. FIG. 5 illustrates an image of the hierarchical clustering in Non Patent Literature 1.

The movement destination candidate calculation unit 32 moves the base station device 10 (on a computer) to the barycentric position of each cluster, and obtains a position candidate where the predicted communication quality after the movement (predicted communication quality in the terminal device 20) is equal to or greater than a predetermined value. That is, the movement destination position candidate of each base station device 10 of which the communication with the terminal device 20 satisfies the required quality is calculated.

For example, it is assumed that there are BS1 and BS2 as target base station devices, and {(BS1, P11), (BS2, P21)} and {(BS1, P12), (BS2, P22)} are obtained as position candidates (Notation as (BS, P)) of BSs based on clustering performed twice with different initial values.

At this time, for example, when the predicted communication quality of only the {(BS1, P11), (BS2, P21)} of the two positions is equal to or greater than a predetermined value, {(BS1, P11), (BS2, P21)} becomes a position candidate.

The calculation method for the predicted communication quality is not limited to a specific method, but for example, a line-of-sight area rate, a predicted throughput integration value, or a required quality achievement terminal rate can be used.

The line-of-sight area rate is a rate of the area of an area where the terminal device 20 is present such that the base station device 10 can be seen from the terminal device 20 (that is, there is no obstacle between the terminal device 20 and the base station 10) in the area of the target area. For example, by dividing the target area into mesh areas, it is possible to obtain the area of the area where the terminal device 20 is present such that the base station device 10 can be seen from the terminal device 20.

As an example, in a case where BS1 and BS2 exist and the positions of BS1 and BS2 are P11 and P21, respectively, when the line-of-sight area rate with the terminal device 20 under the control of BS1 (in the cluster of BS1) is 30% and the line-of-sight area rate with the terminal device 20 under the control of BS2 (in the cluster of BS2) is 20%, the line-of-sight area rate for {(BS1, P11), (BS2, P21)} is 50%.

The predicted throughput integration value is a value obtained by integrating (summing) the predicted throughputs of the terminal device 20 for all the target terminal devices 20. The throughput can be estimated from reception power of a signal from the base station device 10 in the terminal device 20.

The required quality achievement terminal rate is a rate of the terminal devices 20 achieving the required quality among all the target terminal devices 20. The required quality is, for example, a throughput. Since the throughput can be estimated from the reception power as described above, it is possible to determine whether or not the required quality is achieved for each terminal device 20 by comparing the estimated throughput with the required quality.

Note that there is an effect that the calculation amount can be reduced by performing terminal clustering as in the calculation method example 1. In a case where the clustering is not performed, a path loss or the like between each base station device and all the terminal devices in the target area is calculated in all combinations of BS arrangements as described in the calculation method example 2, and the reception quality at a terminal point is obtained. Therefore, the calculation amount increases depending on conditions. On the other hand, by performing the terminal clustering, it is possible to obtain the BS arrangement while reducing the calculation amount by calculating the path loss between the terminal device included in each cluster and the corresponding base station device.

### Calculation Method Example 2:

The movement destination candidate calculation unit 32 calculates the predicted communication quality for all candidates for a position where the base station device 10 can take, and obtains a position candidate for which the predicted communication quality is equal to or greater than a predetermined value. The example of the calculation method for the predicted communication quality is as described above.

For example, it is assumed that there are BS1 and BS2 as target base station devices, and {(BS1, P11), (BS2, P21)} and {(BS1, P12), (BS2, P22)} are obtained as all position candidates (Notation as (BS, P)) taken by BSs.

At this time, for example, when the predicted communication quality of only the {(BS1, P11), (BS2, P21)} of the two positions (positions of BSs) is equal to or greater than a predetermined value, {(BS1, P11), (BS2, P21)} becomes a position candidate.

In both of the calculation method example 1 and the calculation method example 2, as described above, the position candidate is calculated up to the movement destination N times ahead according to the change in the terminal position, and the movement route of each base station device 10 is calculated.

For example, in a case where position candidates are calculated up to two times ahead, it is assumed that there are BS1 and BS2 as the target base station devices, the original position (that is, the current position) is {(BS1, P1), (BS2, P2)}, and two candidates of {(BS1, P1A), (BS2, P2A)} and {(BS1, P1B), (BS2, P2B)} are obtained as the movement destination position candidates for the first movement.

Then, it is assumed that one candidate of {(BS1, P1C), (BS2, P2C)} is obtained as the movement destination position candidate for the second movement.

At this time, for all the target BSs, there are a movement pattern candidate 1 of “{(BS1, P1), (BS2, P2)}→{(BS1, P1A), (BS2, P2A)}→{(BS1, P1C), (BS2, P2C)}” and a movement pattern candidate 2 of “{(BS1, P1), (BS2, P2)}→{(BS1, P1B), (BS2, P2B)}→{(BS1, P1C), (BS2, P2C)}”.

In the movement pattern candidate 1, BS1 moves along a route of “P1→P1A→P1C”, and BS2 moves along a route of “P2→P2A→P2C”. In the movement pattern candidate 2, BS1 moves along a route of “P1→PIB→P1C”, and BS2 moves along a route of “P2→P2B→P2C”.

### <S103>

In S103, the movement cost at which the movement destination position determination unit 33 calculates the movement cost of each base station device 10, and the movement cost is not limited to a specific one. The movement cost is, for example, a movement distance, power consumption required for movement, or time required for movement. The power consumption required for movement can be calculated by integrating the power consumption per unit movement distance obtained in advance with the movement distance. The time required for movement can be calculated by integrating the time per unit movement distance obtained in advance with the movement distance.

For example, in a case where BS1 moves along the route of “P1→P1A→P1C”, the movement distance for B1 is “(Movement distance from P1 to P1A)+(Movement distance from P1A to PC)”.

Furthermore, the power consumption required for movement for B1 is “(Power consumption required for movement from P1 to P1A)+(Power consumption required for movement from P1A to P1C)”. Furthermore, the time required for movement for B1 is “(Time required for movement from P1 to P1A) + (Time required for movement from P1A to P1C)”.

### <S104>

In S104, the movement destination position determination unit 33 determines, as a final movement destination position, a position candidate having the minimum sum of the movement costs for a plurality of movements.

A specific description will be made using the above-described example. As the result in S102, a movement pattern candidate 1 of “{(BS1, P1), (BS2, P2)}→{(BS1, P1A), (BS2, P2A)}→{(BS1, P1C), (BS2, P2C)}” and a movement pattern candidate 2 of “{(BS1, P1), (BS2, P2)}→{(BS1, PIB), (BS2, P2B)}→{(BS1, P1C), (BS2, P2C)}” are obtained as candidates for the movement pattern.

At this time, in the movement pattern candidate 1, it is assumed that the cost for the movement of “P1→P1A →P1C” of B1 is C11 and the cost for the movement of “P2→P2A→P2C” of B2 is C21. Furthermore, in the movement pattern candidate 2, it is assumed that the cost for the movement of “P1→PIB→P1C” of B1 is C12 and the cost for the movement of “P2→P2B→P2C” of B2 is C22.

The movement destination position determination unit 33 calculates C11+C21 as the sum of the movement costs in the movement pattern candidate 1, and calculates C12+C22 as the sum of the movement costs in the movement pattern candidate 2. When the movement destination position determination unit 33 determines that “(C11+C21)<(C12+C22)”, the movement cost of the movement pattern candidate 1 is smaller than that of the movement pattern candidate 2, and thus the movement pattern candidate 1 is selected as the final movement pattern.

### <S105>

In S105, the control unit 34 performs control to move each base station device 10 on the basis of the determination result in S104.

### (Hardware Configuration Example)

The control device 30 can be implemented by, for example, causing a computer to execute a program. This computer may be a physical computer, or may be a virtual machine on a cloud.

Specifically, the control device 30 can be implemented by executing a program corresponding to processing to be performed in the control device 30 by using hardware resources such as a CPU and a memory, which are installed in the computer. The above-described program can be stored and distributed by being recorded on a computer-readable recording medium (portable memory or the like). Furthermore, the program can also be provided via a network such as the Internet or an electronic mail.

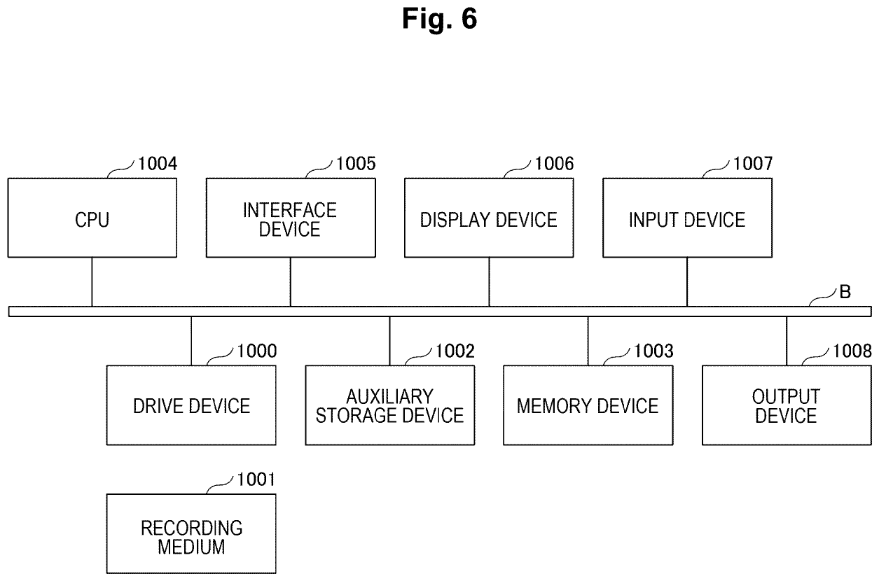

FIG. 6 is a diagram illustrating a hardware configuration example of the computer. The computer in FIG. 6 includes a drive device 1000, an auxiliary storage device 1002, a memory device 1003, a CPU 1004, an interface device 1005, a display device 1006, an input device 1007, and an output device 1008, which are connected to one another by a bus BS.

For example, a program for implementing processing in the computer is provided through a recording medium 1001 such as a CD-ROM or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

In a case where an instruction to start the program is given, the memory device 1003 reads the program from the auxiliary storage device 1002 and stores the program. The CPU 1004 implements a function related to the control device 30 in accordance with the program stored in the memory device 1003. Specifically, the CPU 1004 executes, for example, the procedure illustrated in FIG. 4.

The interface device 1005 is used as an interface for connection to a network or the like. The display device 1006 displays a graphical user interface (GUI) or the like according to the program. The input device 1007 is configured with a keyboard and a mouse, a button, a touch panel, or the like, and is used to input various operation instructions. The output device 1008 outputs a calculation result.

### (Effects of Embodiments)

As described above, in the technology according to the present embodiment, since the movement destination position is determined in consideration of the movement cost, it is possible to suppress deterioration in communication quality during movement and suppress an increase in power consumption for movement when performing movement control on the mobile wireless station device.

In the present embodiment, the movement route of the terminal device can be predicted, and it is possible to suppress the quality deterioration and power consumption in the communication during movement particularly in a case where the mobile wireless station device moves continuously.

Specifically, in the present embodiment, since the control for reducing the movement distance or the movement time is performed, it is possible to suppress the quality deterioration time during the movement of the mobile wireless station device as a whole (in series) to be short when assuming a plurality of movements. The present technology is suitable for a case of relatively high frequent movement.

Furthermore, since control is performed to reduce the power required for movement, it is possible to operate the system with low power consumption when continuous movement is assumed.

### (Supplementary Notes)

The present specification discloses at least a wireless communication system, a control device, a movement destination position determination method, and a program below.

### (Supplementary Note 1)

A wireless communication system including:

one or more mobile wireless station devices that communicate with one or more terminal devices; and

a control device,

in which the control device

calculates, on the basis of a prediction value of a position of each of the terminal devices, a movement destination position candidate of each of the mobile wireless station devices of which communication with the terminal device satisfies a required quality for each of a plurality of movements, and

selects, as a combination of movement destination positions for movement control, a combination that minimizes a sum of movement costs for the plurality of movements from an original position of each of the mobile wireless station devices from among a plurality of the combinations of the movement destination position candidates in the plurality of movements.

### (Supplementary Note 2)

The wireless communication system according to supplementary note 1,

in which the control device calculates the movement destination position candidate of each of the mobile wireless station devices by performing clustering on the terminal device.

### (Supplementary Note 3)

A control device in a wireless communication system including one or more mobile wireless station devices that communicate with one or more terminal devices, and the control device, the control device including:

a memory; and

at least one processor connected to the memory,

in which the processor

calculates, on the basis of a prediction value of a position of each of the terminal devices, a movement destination position candidate of each of the mobile wireless station devices of which communication with the terminal device satisfies a required quality for each of a plurality of movements, and

selects, as a combination of movement destination positions for movement control, a combination that minimizes a sum of movement costs for the plurality of movements from an original position of each of the mobile wireless station devices from among a plurality of the combinations of the movement destination position candidates in the plurality of movements.

### (Supplementary Note 4)

The control device according to supplementary note 3,

in which the processor calculates the movement destination position candidate of each of the mobile wireless station devices by performing clustering on the terminal device.

### (Supplementary Note 5)

A movement destination position determination method in a wireless communication system including one or more mobile wireless station devices that communicate with one or more terminal devices, and a control device, the method including:

by the control device, a step of calculating, on the basis of a prediction value of a position of each of the terminal devices, a movement destination position candidate of each of the mobile wireless station devices of which communication with the terminal device satisfies a required quality for each of a plurality of movements, and

by the control device, a step of selecting, as a combination of movement destination positions for movement control, a combination that minimizes a sum of movement costs for the plurality of movements from an original position of each of the mobile wireless station devices from among a plurality of the combinations of the movement destination position candidates in the plurality of movements.

### (Supplementary Note 6)

A non-transitory storage medium storing a program for causing a computer to function as each unit in the control device according to Supplementary note 3 or 4.

Although the present embodiments have been described above, the present invention is not limited to the specific embodiments, and various modifications and changes can be made within the scope of the gist of the present invention disclosed in the claims.

### REFERENCE SIGNS LIST

10 Base station device
11 Drive unit
20 Terminal device
30 Control device
31 Terminal position prediction unit
32 Movement destination candidate calculation unit
33 Movement destination position determination unit
34 Control unit
35 Environment grasping unit
1000 Drive device
1001 Recording medium
1002 Auxiliary storage device
1003 Memory device

### 1004 CPU

1005 Interface device
1006 Display device
1007 Input device
1008 Output device

1. A radio communication system comprising:
one or more mobile wireless station devices configured to communicate with one or more terminal devices; and
a control apparatus including circuitry configured to:
calculate, based on a prediction value of a position of each of the terminal devices, a candidate destination position of each of the mobile wireless station devices where communication with the terminal devices satisfies a required quality for each of a plurality of movements, and
select, as a combination of destination positions for movement control, a combination that minimizes a sum of movement costs for the plurality of movements from an original position of each of the mobile wireless station devices, from among a plurality of combinations of candidate destination positions in the plurality of movements.

2. The radio communication system according to claim 1, wherein the circuitry of the control apparatus is configured to calculate the candidate destination position of each of the mobile wireless station devices by performing clustering of the terminal devices.

3. A control apparatus in a radio communication system including (i) one or more mobile wireless station devices configured to communicate with one or more terminal devices, and (ii) the control apparatus, comprising:
circuitry configured to:
calculate, based on a prediction value of a position of each of the terminal devices, a candidate destination position of each of the mobile wireless station devices where communication with the terminal devices satisfies a required quality for each of a plurality of movements; and
select, as a combination of destination positions for movement control, a combination that minimizes a sum of movement costs for the plurality of movements from an original position of each of the mobile wireless station devices, from among a plurality of the combinations of candidate destination positions in the plurality of movements.

4. The control apparatus according to claim 3, wherein the circuitry is configured to calculate the candidate destination position of each of the mobile wireless station devices by performing clustering of the terminal devices.

5. A move destination position determination method executed by a control apparatus in a radio communication system including:
one or more mobile wireless station devices that communicate with one or more terminal devices, and
the control apparatus, the method comprising:
calculating, based on a prediction value of a position of each of the terminal devices, a candidate destination position of each of the mobile wireless station devices where communication with the terminal devices satisfies a required quality for each of a plurality of movements, and
selecting, as a combination of destination positions for movement control, a combination that minimizes a sum of movement costs for the plurality of movements from an original position of each of the mobile wireless station devices, from among a plurality of combinations of candidate destination positions in the plurality of movements.

6. A non-transitory computer readable storage medium storing a program for causing a computer to execute the move destination position determination method of claim 5.
